(19) United States
(12) Patent Application Publication
(10) Pub. No.: US 2014/0154498 A1
(43) Pub. Date: Jun. 5, 2014

(54) MULTILAYER FILM STRUCTURES

(71) Applicants: Mark Lockhart, Fairport, NY (US); Robert Sheppard, Victor, NY (US)

(72) Inventors: Mark Lockhart, Fairport, NY (US); Robert Sheppard, Victor, NY (US)

(21) Appl. No.: 14/176,886

(22) Filed: Feb. 10, 2014

Related U.S. Application Data
(63) Continuation-in-part of application No. 13/531,026, filed on Jun. 22, 2012.
Application No. 13/531,026 is a continuation-in-part of application No. 13/002,886, filed on Feb. 17, 2011.
(60) Provisional application No. 61/079,466, filed on Jul. 10, 2008.

(51) Int. Cl. B32B 27/32; B32B 27/08; B32B 27/20; B29C 59/02

(52) U.S. Cl. CPC B32B 27/32; B29C 59/026; B32B 27/08; B32B 27/20
USPC 428/316.6; 264/45.1; 264/293; 425/385; 428/304.4; 428/319.9

(57) ABSTRACT

Disclosed, among others, are a multilayer film that permits thermal printing or printing by application of pressure from pressure-applying devices. The structure includes an extruded, outer skin layer and an extruded internal pigment layer. Further, the structure includes an extruded image-rendering layer intermediate to the outer skin layer and the pigment layer, the image-rendering layer including a collapsible layer structure, sensitive to the application of temperature and/or pressure, having dispersed therein a plurality of voids, the collapsible layer structure in uncollapsed condition being substantially opaque to obscure from view the pigment layer there beneath. The collapsible layer structure is selectively collapsible by application of temperature and/or pressure to temporarily elevate localized temperature or pressure at the collapsible layer structure at select locations, so as to provide substantially transparent collapsed structure at the select locations, the pigment layer being visible through the substantially transparent collapsed structure.

### REFERENCE TO RELATED APPLICATIONS

The present application is a continuation-in-part of, and claims priority to U.S. patent application Ser. No. 13/531,026 filed Jun. 22, 2012, U.S. patent application Ser. No. 13/002,886 filed Jan. 2, 2011, and U.S. patent application Ser. No. 61/079,466, filed Jul. 10, 2008, each of which is hereby incorporated by reference in its entirety.

### FIELD

This disclosure relates to polyolefin multilayer films (i.e., films, structures, articles, etc.) that permit thermal printing and/or printing by application of pressure from pressure-applying devices, such as embossing through use of embossers, an impact printer, etc. Furthermore, this disclosure relates to resin compositions for forming the foregoing, methods for forming multilayers film that permit thermal printing or printing by application of pressure from pressure-applying devices, methods that permit thermal printing or printing by application of pressure from pressure-applying devices, and apparatuses for the foregoing.

### BACKGROUND

Polyolefin multilayer films are widely used in applications such as, for example, packaging, tags and labels. Polyolefin multilayer films may be printed in connection with their various uses.

### SUMMARY

Improved polyolefin multilayer films for use in thermal printing and/or printing by pressure-applied devices are disclosed. As used herein, the term “thermal printing” means rendering an image, or images, in a multilayer films by elevating the temperature, pressure, or both, of a select portion of the multilayer films so as to make visible at least one corresponding pigment region in the multilayer films. Although this disclosure largely presents its disclosure in terms of thermal printing, it is understood that embodiments, instead, may permit printing by pressure-applied devices or printing by both thermal and pressure applying devices. Accordingly, as used herein, “thermal printing” may include thermal printing, and, particularly, direct thermal printing, thermal imaging, and printing by combination of elevating temperature, pressure, or both, of a select portion of a multilayer film relative to printing apparatus such as, for example, the print head of a thermal printer. As used herein, the term “image-rendering properties” refers to properties of a multilayer film relating to capability for affecting or rendering an image in or upon the multilayer film, specifically by thermal printing. Embodiments provide multilayer films for thermal printing and which have improved image-rendering properties.

According to some embodiments, multilayer films for printing may comprise a core layer, an outer skin layer, a pigment layer intermediate to the core layer and outer layer, and an image-rendering tie layer intermediate to the pigment layer and outer layer, the image rendering tie layer having image-rendering properties. Embodiments include resin compositions for forming multilayer films, and layers thereof, as described. Embodiments include methods for forming multilayer films for thermal printing. Embodiments provide methods and apparatuses for thermal printing of multilayer films. As will be understood by those of skill in the art, various shortcomings, disadvantages and problems of multilayer films, methods and apparatus are identified and resolved by the subject matter of this disclosure.

### BRIEF DESCRIPTION OF DRAWINGS

FIG. 1 is a schematic layer diagram illustrating embodiments.

FIG. 2 is a graphical display of print contrast in relation to print speed for embodiments.

FIG. 3 is a graphical display of image density in relation to print speed for embodiments.

FIG. 4 is a tabular display of reflectance and optical density for embodiments.

### DETAILED DESCRIPTION OF EMBODIMENTS

In this detailed description of embodiments, reference is made to the accompanying drawings that form a part hereof, and in which are shown by way of illustration specific embodiments that may be practiced. Embodiments are described in sufficient detail to enable those skilled in the art to practice the embodiments and the full scope of the claims. It will be understood by one of ordinary skill that embodiments, other than the illustrative embodiments specifically described in this section, may be utilized and that logical, compositional, conditional, mechanical and other changes may be made without departing from the scope of the embodiments and this disclosure. Except as otherwise dictated by context, or the knowledge of those of ordinary skill, any reference herein to an “embodiment” or “embodiments” may refer to one or more, but not necessarily all, embodiments of the subject matter herein disclosed. The following detailed description is, therefore, not to be taken in a limiting sense and shall not limit the scope of the claims.

The term “comprising” and its derivatives are not intended to exclude the presence of any additional component, step or procedure, whether or not the same is specifically disclosed. In order to avoid any doubt, any process or composition claimed through use of the term “comprising” may include any additional steps, equipment, additive, adjuvant, or compound whether polymeric or otherwise, unless stated to the contrary. The term “or”, unless stated otherwise, refers to the listed members individually as well as in any combination.

Unless stated to the contrary, implicit from the context, or customary in the art, all parts and percentages are based on weight and all test methods are current as of the filing date of this disclosure. The contents of any referenced patent, patent application or publication are hereby incorporated by this reference in its entirety, especially with respect to the disclosure of synthetic techniques, definitions (to the extent not inconsistent with any definitions specifically provided in the instant disclosure), and general knowledge in the art.

Numerical ranges referenced herein include all values from and including the lower and the upper values, in increments of one unit, provided that there is a separation of at least two units between any lower value and any higher value. As an example, if a compositional, physical or other property or process parameter, such as, for example, lamination bond strength is from 100 to 1,000, it is intended that all individual values, such as 100, 101, 102, etc., and sub ranges, such as 100 to 144, 155 to 170, 197 to 200, etc., are expressly enumerated. For ranges containing values that are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered as expressly stated in this disclosure.

For the purposes of this disclosure, conventional or standard methods and conditions used to measure or describe properties are those understood by one of skill in the art from the context of the disclosure, or stated herein. These include, but are not limited to, the following:
(a) color density or optical density (“optical density”) may be determined and understood according to, for example, by use of a suitable densitometer or other suitable procedure. A suitable densitometer, for example, is an Xrite™ 500 Series Densitometer available from Xrite™ (Grandville, Mich.).
(b) reflectance may be described and understood, for example, by conversion of optical density as described in the preceding statement, subject to any reasonable variations that are understood by those of skill in the art. For example, where optical density is (D) and % Reflection is (R), R may be determined: R=( 1/10^{D})×100 and D=|log₁₀ (1/% R)|
(c) print contrast signal (PCS) may be understood, for example, as being equal to (Space Reflectance−Bar Reflectance)/Space Reflectance (source: Pitney Bowes Standards), subject to any reasonable variations that are understood by those of skill in the art.

“Composition” and like terms, as used herein, means a mixture of two or more materials. It will be understood that the term “composition” does not imply or require the occurrence, or non-occurrence, of any chemical reaction. It will be understood that embodiments according to this disclosure provide multilayer films, compositions and methods in which chemical reactions are not required during extrusion and orienting. It will also be understood, however, that embodiments are not excluded by the occurrence of one or more chemical reactions, which for example may occur in a manner incidental or complementary to the disclosed subject matter. It is believed that the compositions disclosed herein do not require or contemplate the occurrence of chemical reactions during mixing or blending of resin compositions, or during extrusion and orienting of multilayer films produced from such resin compositions. It will be understood that specifically referenced and described herein are “resin compositions for multilayer films,” or layers thereof, and that this terminology is intended to identify and disclose compositions from which may be formed corresponding multilayer films by processing under specified or known conditions, or, in specified or known equipment, such as equipment for extrusion and orienting.

As used therein the term “extrusion” is intended to include extrusion, co-extrusion, blown extrusion, extrusion coating, or combinations thereof, whether by tubular methods, planar methods, or combinations thereof as may be utilized to produce multilayer films.

As used herein, the term “oriented” material is defined herein as a material, multilayer film, or layer thereof, which has been formed by extrusion and thereafter has been oriented by use of tenter orienting apparatus, or other suitable orienting apparatus, to stretch the subject material below the melting point (MP) thereof, in at least one orienting direction. For example, extruded film may be uniaxially oriented by being stretched in one direction, such as machine direction (“MD”) or transverse direction (“TD”). Also for example, extruded film may be biaxially oriented by use of tenter orienting apparatus operated to stretch the extruded material in a machine direction (“MD”) and in a transverse direction (“TD”). It will be understood that “oriented” material includes, at least, uniaxially oriented and biaxially oriented multilayer films. It will be further understood that according to embodiments herein disclosed, multilayer films having one or more voided layers may be formed by orientation, such as for example by suitable biaxial orientation, of an extruded multilayer film, including a void layer having therein a suitable voiding agent or cavitating agent, so as to stress the polymer matrix of the void layer and thus form a voided layer having therein a large number of voids. It will be understood that the voids refract light and thus create opacity of the voided layer.

Unless specifically set forth and defined or otherwise limited, “polymer” means a compound prepared by polymerizing monomers, whether of the same or a different type. The term “polymer” as used herein generally may include, but is not limited to, homopolymers, copolymers, such as, for example, block, graft, random and alternating copolymers, terpolymers, etc. and blends and modifications thereof.

Unless specifically set forth and defined or otherwise limited, “elastomers” refer to copolymers of either propylene or ethylene with lower crystallinity, lower modulus of elasticity, lower melting temperatures, and lower density relative to semi-crystalline polymers of polypropylene or polyethylene.

As used herein, the term “polyethylene” as used herein refers to families of resins commonly identified as polyethylene resins and obtained, generally, by substantial polymerization of ethylene.

As used herein, the term “HDPE” means “high density polyethylene” and refers to polyethylene having a density greater than about 0.935 g/cm³ and a melting point of about 130° C.

The term “polypropylene” as used herein, is a type of polyolefin that may be employed in a multilayer film of the present invention, and refers to families of resins obtained by substantially polymerizing the gas propylene, C₃H₆.

The term “antiblocking material” means a material used to prevent or reduce adhesion between film layers during manufacture. Antiblocking material may include, for example, silica, silicone fluid, fully crosslinked silicon spheres, and poly(methyl methacrylate) or “PMMA”.

The term “propylene-based polymer,” as used herein, refers to a polymer that comprises a majority weight percent polymerized propylene monomer (based on the total weight of polymerizable monomers), and optionally may comprise at least one (or more) polymerized comonomer(s), such as ethylene. The propylene-based polymer may be a propylene homopolymer or copolymer.

The term “ethylene-propylene copolymer,” as used herein, refers to a polymer that comprises polymer units derived from ethylene monomers, polymer units derived from propylene monomers and, optionally, polymer units derived from at least one other a-olefin monomer. In an ethylene-propylene copolymer, either the polymerized ethylene monomers or the polymerized propylene monomers constitute a majority weight percent of the polymer.

The term “metallocene catalyzed copolymers” means a copolymer, wherein polymerization of the monomers has been accomplished in the presence of a metallocene catalyst such as, for example, hafnium (Hf) or other Group IV metal.

The term “hydrogenated hydrocarbon resin” (or “HCR”) means any of the families of resins obtained by the substantial hydrogenation of hydrocarbons such as, e.g., polyterpenes, OPPERA™ HCR resins (ExxonMobil™ Chemical Company, Houston, Tex.), and Regalite™ resins (Eastman™ Chemical, Kingsport, Tenn.), etc.

The term “cavitating agent” means void-initiating particles added to one or more layers (“voided layer”) of a multilayer film for creating a substantially opaque layer by stressing the polymer matrix of the voided layer to form a large number of voids therein. Suitable cavitating agents may include any suitable organic or inorganic material that is incompatible with the polymer material(s) contained in the layer(s) to which the cavitating agent is added, at the temperature of biaxial orientation. Examples of suitable void-initiating particles may include, but are not limited to, PMMA, zeolite, calcium carbonate (CaCO₃), polybutylene terephthalate (“PBT”), nylon, cyclic-olefin copolymers, solid or hollow pre-formed glass spheres, ceramic spheres, talc, chalk, and combinations thereof. In some embodiments, the average diameter of the void-initiating particles may range from about 0.1 μm to 20 μm. The particles may be of any desired shape such as, for example, substantially spherical. Alternatively, “cavitating agent” may include β-form crystals of polypropylene that are converted to α-form crystals during orientation and leaving respective voids in the layer.

In some embodiments, cavitating agents may be present in the respective voided layer at about 5 wt. % up to about 50 t. %, but may be higher or lower. It will be understood that the proportion of cavitating agent necessary to achieve desired opacity in an image-rendering layer may be greater where the image-rendering layer is relatively thin (i.e., has reduced layer thickness), and that a relatively thick (i.e., has greater layer thickness) image-rendering layer will require a lower proportion of cavitating agent to achieve comparable opacity. However, it is noted that there is a point of diminishing return on adding cavitating agent to a polymer in order to create opacity. It will be understood that a relatively thin image-rendering layer of reduced layer thickness may enable relatively higher printing speeds. In some embodiments, particles of the cavitating agent have a refractive index that is comparable or similar to the polymer matrix or collapsible layer structure of the voided layer, such that the particles are not readily visible in substantially transparent collapsed layer structure formed by thermal printing.

Embodiments provide multilayer films in which an image may be rendered by digital thermal printing, without ink being applied thereto or use of a print ribbon or special coatings, and, thus, the image rendering elements are fully contained in the film. Embodiments provide multilayer films in which an image may be rendered, and which is light weight. Embodiments provide multilayer films in which an image may be rendered, and which are of low cost relative to conventional direct thermal media and thermal transfer ribbon technology.

Embodiments provide multilayer films for thermal printing or embossing, comprising a core layer, outer skin layer, an extruded pigment layer, an extruded image-rendering layer between the outer skin layer and pigment layer, the image-rendering layer having voids formed therein, the image-rendering layer including a thermally collapsible layer structure, which is thermally deformable to provide collapsed layer structure at collapsed voids therein at select locations, the pigment layer proximate the select locations being visible through the collapsed layer structure of the image-rendering layer. Similarly, example embodiments may permit collapse of the collapsible layer structure by application of pressure from a pressure-applying device, such as an embosser or impact printer. In other embodiments, collapse of the collapsible layer structure for a particular multilayer film may be achieved by temperature or pressure or the combination of temperature and pressure.

In an embodiment, a multilayer film in an initial condition (i.e., prior to thermal printing) comprises a substantially uniform image-rendering layer including a substantially opaque thermally collapsible layer structure of substantially uniform thickness and having therein a plurality of voids in an oriented polymer matrix. It will be understood that the image-rendering layer including voids may be formed, for example, by biaxial orientation of a suitable extruded multilayer film including an extruded image-rendering layer having dispersed therein a suitable cavitating agent. It will be understood that the image-rendering structure having the thermally collapsible layer structure is made substantially opaque by the plurality of voids, and, thus, obscures from view a pigment layer beneath the image-rendering layer. The multilayer film in a subsequent printed condition (i.e., subsequent to thermal printing thereof) comprises an unprinted area and a printed area adjacent thereto. It will be understood that in many specific arrangements, a particular image-rendering layer may include multiple unprinted areas and printed areas adjacent thereto. The image-rendering layer in the unprinted area remains substantially unchanged from thermal printing, and, thus, may include a substantially opaque thermally collapsible layer structure of substantially uniform thickness and having therein a plurality of voids. The image-rendering layer in the printed area, being collapsed by thermal printing in select locations adjacent to the undisturbed thermally collapsible layer structure of the unprinted area, in the select locations of collapsed voids may include substantially transparent collapsed layer structure of substantially reduced thickness. The pigment layer thus is exposed to view beneath the substantially transparent collapsed layer structure in the printed area, and is obscured from view beneath the substantially opaque undisturbed thermally collapsible layer structure in the unprinted area. The image-rendering layer in the printed area thus exposes to view at select locations the pigment layer beneath the substantially transparent collapsed layer structure thereof. It will be understood that during thermal printing the thermally collapsible layer structure of the image-rendering layer is collapsed at select locations by temporarily elevating localized temperature to the melting point of the thermally collapsible layer structure at the select locations, such that substantially transparent collapsed layer structure is formed at collapsed voids at the select locations exposes to make visible the pigment layer beneath. It will be understood that contrast between undisturbed, opaque uncollapsed layer structure adjacent printed, i.e., thermally collapsed, substantially transparent collapsed layer structure, defines the image to be viewed.

The image-rendering layer in the printed area, having a substantially transparent collapsed layer structure, is thinner than the uncollapsed layer structure of substantially uniform height in the adjacent unprinted area. The “collapsed layer structure” may include any partially collapsed layer structure having desired or sufficient transparency relative to a substantially uncollapsed layer structure of greater opacity. It will be understood that opacity of uncollapsed layer structure in the image-rendering layer is provided by the plurality of voids existing therein. In an embodiment, a multilayer film comprises an outer skin layer above the image-rendering layer. In an embodiment, the outer skin layer may be co-extruded on top of the image-rendering layer.

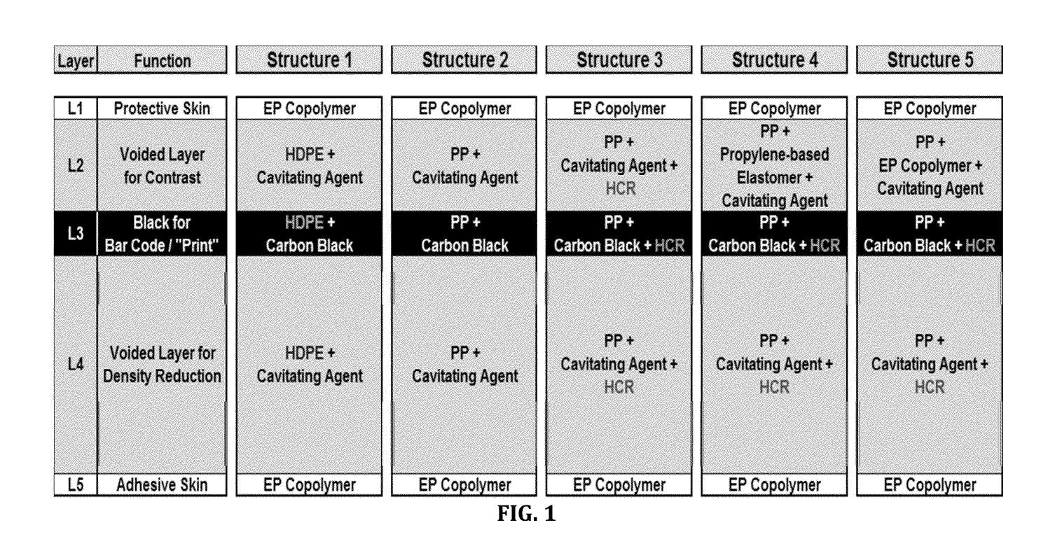

FIG. 1 is a comparative schematic layer diagram of embodiments. As shown in each layer diagram of FIG. 1, in embodiments a multilayer film for thermal printing may include an extruded substantially transparent outer skin layer, which may include at least one of the following: ethylene-propylene copolymer, polyethylene, high density polyethylene, medium density polyethylene, linear low density polyethylene, propylene homopolymers, terpolymers, matter resins, antiblocking additives, and slip agents. As illustrated in each layer diagram of FIG. 1, in embodiments the outer skin layer may be formed by extrusion of a film of suitable polymer or polymer blend such as, for example, ethylene-propylene copolymer. The extruded outer skin layer may be configured to render the multilayer film impervious to a wide range of chemicals and solvents. The extruded outer skin layer may provide abrasion resistance for the multilayer film. In embodiments, as shown in FIG. 1, a multilayer film may include identical, or different, outer skin layers at each of the outermost layers thereof. In embodiments, as shown in FIG. 1, the extruded outer skin layer may provide reduced abrasive wear on the print heads and related wear components of equipment such as, for example, a thermal printer.

As illustrated in each layer diagram of FIG. 1, various embodiments of a multilayer film may include an extruded core layer. As shown in a schematic layer diagram at left in FIG. 1, in an embodiment, the core layer may be formed of a suitable polymer such as, for example, high density polyethylene (HDPE). In embodiments, the core layer may be a voided layer or a non-voided layer. It will be understood that the core layer may be substantially or partially transmissive of light, may be relatively transparent, or may be relatively opaque. It will be understood that the core layer may include a large number of voids that function to create desired opacity, without an opacifying agent. It will also be understood that, in some embodiments, a core layer may include a large number of voids that imparts desirable physical properties such as, for example, making the core layer relatively lightweight relative to the thickness and stiffness thereof. It will be understood that some embodiments, wherein the core layer is located beneath a pigmented layer that is associated with forming an image viewable from above, rather than being viewable through the core layer below, may include an opacifying agent, such as titanium dioxide (TiO₂); this or other suitable opacifying agent(s), or combinations thereof, may synergistically contribute to opacity when present within a voided layer. As shown in schematic layer diagrams in four columns at right in FIG. 1, in embodiments, the core layer may be formed of a suitable polymer such as, for example, polypropylene (PP). As shown in schematic layer diagrams in each of the three columns at right in FIG. 1, in an embodiment, the core layer may be formed of a suitable mixture including a suitable polymer such as, for example, high density polyethylene (HDPE), polypropylene (PP), hydrogenated hydrocarbon resin (HCR), and combinations thereof, and may further include a cavitating agent to provide a voided layer structure. It will be understood that the core layer may include an opacifying agent such as titanium dioxide (TiO₂) or other suitable opacifying agent(s) or combinations thereof.

As illustrated in each layer diagram of FIG. 1, in embodiments, a multilayer film may include an extruded internal pigment layer intermediate to the core layer and outer skin layer, and particularly beneath an image-rendering layer and adjacent the core layer. It will be understood that, as illustrated in each layer diagram of FIG. 1, in embodiments the pigment layer includes a suitable pigment or other colorant such as, for example, carbon black. The pigment layer may or may not be voided. As shown in a schematic layer diagram at left in FIG. 1, in an embodiment, the pigment layer may be formed of a suitable polymer such as, for example, high density polyethylene (HDPE). As shown in schematic layer diagrams in each of the four columns at right in FIG. 1, in an embodiment, the pigment layer may be formed of a suitable polymer such as, for example, polypropylene (PP). As shown in schematic layer diagrams in each of the three columns at right in FIG. 1, in an embodiment, the pigment layer may be formed of a suitable mixture including a suitable polymer such as, for example, polypropylene (PP) and hydrogenated hydrocarbon resin (HCR).

As illustrated in each layer diagram of FIG. 1, in embodiments, a multilayer film for thermal printing may include an extruded image-rendering tie layer (“image-rendering layer”) intermediate to the outer skin layer and the pigment layer. In embodiments, the image-rendering layer may be a voided layer which includes a thermally collapsible layer structure having dispersed therein a plurality of voids which provide opacity of the image-rendering layer. It will be understood that the plurality of voids may be formed by orienting, such as by biaxial orientation, the image-rendering layer having a cavitating agent dispersed therein, to stress the polymer matrix forming the thermally collapsible layer structure thereof. The image-rendering layer, including a thermally collapsible layer structure in uncollapsed condition, may be of substantially uniform height and may be substantially opaque due to the presence of a plurality of voids, to obscure from view the pigment layer beneath and behind the image-rendering layer. The thermally collapsible layer structure is selectively collapsible by thermal printing to temporarily elevate localized temperature of the thermally collapsible layer structure to the melting point of the polymer matrix material that forms the collapsible layer structure at select locations, so as to provide substantially transparent collapsed void structure at the select locations. It will be understood that, in embodiments wherein the polymer matrix forming the thermally collapsible layer structure is polypropylene, the melting point is about 162-165° C. It will be understood that, in embodiments wherein the polymer matrix forming the thermally collapsible layer structure is polyethylene, the melting point is about 130° C. It will be understood that the pigment layer is made visible through the substantially transparent collapsed layer structure at select locations. It will be understood that contrast between the opaque, white thermally collapsible layer structure which remain in uncollapsed condition at unprinted areas, and the pigment layer viewed through the substantially transparent collapsed layer structure at the select locations, may define and provide a desired image for viewing. It will be understood, further, that substantial advantages such as, for example, improved image quality and reduced material cost may be provided by the image-rendering layer including a thermally collapsible layer structure that may be selectively collapsible by thermal printing to temporarily elevate localized temperature to cause local deformation and collapse of the thermally collapsible layer structure at the melting point thereof at select locations.

As shown in the layer diagram in a column identified as Structure 1 in FIG. 1, a multilayer film may include thermally collapsible layer structure comprising high density polyethylene. It will be understood that thermally collapsible layer structure comprising high density polyethylene may collapse by deformation thereof when localized temperature of the material is temporarily elevated to about 130° C.

As shown in the layer diagram in a column identified as Structure 2 of FIG. 1, a multilayer film may include thermally collapsible layer structure comprising polypropylene. It will be understood that thermally collapsible layer structure comprising polypropylene may collapse by deformation thereof when localized temperature of the material is temporarily elevated to the melting point of polypropylene, which is about 162-165° C.

As shown in the layer diagram in a column identified as Structure 3 of FIG. 1, a multilayer film may include thermally collapsible layer structure comprising polypropylene and hydrogenated hydrocarbon resin (HCR). It will be understood that thermally collapsible layer structure comprising polypropylene and hydrogenated hydrocarbon resin may collapse by two step deformation thereof when localized temperature of the material is temporarily elevated to the melting point of the hydrogenated hydrocarbon resin below the melting point of polypropylene, and then elevated to the melting point of polypropylene. Suitable commercially available products are, for example, the OPPERA™ family of resins from ExxonMobil™ Chemical Company (Houston, Tex.).

It will be understood by reference to the layer diagram in the column identified as Structure 4 of FIG. 1 that a multilayer film may include a thermally collapsible layer structure comprising a propylene-based elastomer. It will be understood that thermally collapsible layer structure comprising propylene-based elastomer may collapse by deformation thereof when localized temperature of the material is temporarily elevated to the melting point of the propylene-based elastomer. Suitable commercially available propylene-based elastomer products are, for example, selected from the Vistamaxx™ family of VMX™ series products, such as VMX 6100, available from ExxonMobil™ Chemical.

It will be understood by reference to the layer diagram in the column identified as Structure 5 of FIG. 1 that a multilayer film may include thermally collapsible layer structure comprising an ethylene-propylene copolymer. It will be understood that thermally collapsible layer structure comprising ethylene-propylene copolymer may collapse by deformation thereof when localized temperature of the material is temporarily elevated to the melting point of ethylene-propylene copolymer. It will be understood that thermally collapsible layer structure comprising ethylene-propylene copolymer may have a lower melting point than propylene. Suitable commercially available ethylene-propylene copolymer products for example, may be selected from the polyefin family of products, such as 8573 available from Total Petrochemicals and Refining USA (Houston, Tex.).

Referring to FIG. 1, in an embodiment, a multilayer film for thermal printing, may include an extruded substantially transparent outer skin layer, an extruded inner core layer comprising polyethylene, an extruded interior pigment layer intermediate to the inner core layer and outer skin layer, the pigment layer comprising polyethylene. A multilayer film may include an extruded image-rendering layer intermediate to the outer skin layer and the pigment layer, the image-rendering layer being a voided layer including a thermally collapsible layer structure comprising polyethylene having dispersed therein a plurality of voids, the thermally collapsible layer structure in uncollapsed condition being substantially opaque to obscure from view the pigment layer there beneath. It will be understood that desired opacity of the image-rendering layer may be provided by the voids formed therein and which refract light. In an embodiment, the thermally collapsible layer structure may be selectively collapsible by thermal printing to temporarily elevate localized temperature of the thermally collapsible layer structure to the melting point of the polymer matrix material forming same at select locations, so as to provide substantially transparent collapsed structure at the select locations, such that the pigment layer is visible through the substantially transparent collapsed layer structure at the select locations. In an embodiment, the outer skin layer comprises ethylene-propylene copolymer. A suitable commercially available product is, for example, 8573 from Total Petrochemicals and Refining USA (Houston, Tex.).

Referring to FIG. 1, in an embodiment, a multilayer film for thermal printing may comprise an extruded, substantially transparent outer skin layer; an extruded inner core layer comprising high density polyethylene; an extruded interior pigment layer intermediate to the inner core layer and outer skin layer, the pigment layer comprising high density polyethylene. The multilayer film may include an extruded image-rendering layer intermediate to the outer skin layer and the pigment layer, the image-rendering layer being a voided layer including a thermally collapsible layer structure comprising high density polyethylene having dispersed therein a plurality of voids. The thermally collapsible layer structure in uncollapsed condition may be substantially opaque to obscure from view the pigment layer there beneath, and the thermally collapsible layer structure may be selectively collapsible by deformation by thermal printing to temporarily elevate localized temperature of the thermally collapsible layer structure to the melting point of polymer material forming same at select locations, so as to provide substantially transparent collapsed layer structure at the select locations. The pigment layer may be made visible through the substantially transparent collapsed structure.

Referring to FIG. 1, in an embodiment, a multilayer film for thermal printing may include an extruded, substantially transparent outer skin layer; an extruded inner core layer comprising polypropylene and hydrogenated hydrocarbon resin; an extruded interior pigment layer intermediate to the inner core layer and outer skin layer, the pigment layer comprising polypropylene and hydrogenated hydrocarbon resin. The multilayer film may include an extruded image-rendering layer intermediate to the outer skin layer and the pigment layer, the image-rendering layer being a voided layer including a thermally collapsible layer structure comprising high density polyethylene having dispersed therein a plurality of voids. In an embodiment, the thermally collapsible layer structure in uncollapsed condition may be substantially opaque to obscure from view the pigment layer there beneath, and the thermally collapsible layer structure may be selectively collapsible by deformation by thermal printing to temporarily elevate localized temperature of the thermally collapsible layer structure to the melting point of polymer material forming same at select locations, so as to provide substantially transparent collapsed layer structure at the select locations. The pigment layer may be made visible through the substantially transparent collapsed void structure.

Referring to FIG. 1, in an embodiment, a multilayer film may include an extruded, substantially transparent outer skin layer; an extruded inner core layer comprising polypropylene and hydrogenated hydrocarbon resin; an extruded interior pigment layer intermediate to the inner core layer and outer skin layer, the pigment layer comprising polypropylene and hydrogenated hydrocarbon resin; and an extruded image-rendering layer intermediate to the outer skin layer and the pigment layer, the image-rendering layer being a voided layer including a thermally collapsible layer structure comprising polypropylene and hydrogenated hydrocarbon resin having dispersed therein a plurality of voids. The thermally collapsible layer structure in uncollapsed condition may be substantially opaque to obscure from view the pigment layer there beneath, and the thermally collapsible layer structure may be selectively collapsible by deformation by thermal printing to temporarily elevate localized temperature of the thermally collapsible layer structure to the melting point of polymer material forming same at select locations, so as to provide substantially transparent collapsed layer structure at the select locations. The pigment layer may be made visible through the substantially transparent collapsed structure.

Referring to FIG. 1, in an embodiment, a multilayer film for thermal printing or action by pressure-applying device, may comprise an extruded, substantially transparent outer skin layer; an extruded inner core layer comprising polypropylene and hydrogenated hydrocarbon resin; an extruded interior pigment layer intermediate to the inner core layer and outer skin layer, the pigment layer comprising polypropylene and hydrogenated hydrocarbon resin; and an extruded image-rendering layer intermediate to the outer skin layer and the pigment layer, the image-rendering layer being a voided layer including a thermally collapsible layer structure comprising polypropylene and propylene-based elastomer having dispersed therein a plurality of voids. The thermally collapsible layer structure in uncollapsed condition may be substantially opaque to obscure from view the pigment layer there beneath, and the thermally collapsible layer structure may be selectively collapsible by deformation by thermal printing to temporarily elevate localized temperature of the thermally collapsible layer structure to the melting point of polymer material forming same at select locations, so as to provide substantially transparent collapsed layer structure at the select locations. The pigment layer may be made visible through the substantially transparent collapsed structure.

Referring to FIG. 1, in an embodiment, a multilayer film, may include an extruded, substantially transparent outer skin layer; an extruded inner core layer comprising polypropylene and hydrogenated hydrocarbon resin; an extruded interior pigment layer intermediate to the inner core layer and outer skin layer, the pigment layer comprising polypropylene and hydrogenated hydrocarbon resin; and an extruded image-rendering layer intermediate to the outer skin layer and the pigment layer. The image-rendering layer may be a voided layer including a thermally collapsible layer structure comprising polypropylene and propylene-based elastomer having dispersed therein a plurality of voids, the thermally collapsible layer structure in uncollapsed condition being substantially opaque to obscure from view the pigment layer there beneath, and wherein the thermally collapsible layer structure is selectively collapsible by deformation by thermal printing to temporarily elevate localized temperature of the thermally collapsible layer structure to the melting point of polymer material forming same at select locations, so as to provide substantially transparent collapsed layer structure at the select locations. The pigment layer may be made visible through the substantially transparent collapsed structure.

In an embodiment, a multilayer film may include in an image-rendering layer propylene and propylene-based elastomer comprising a commercially available product selected from the Vistamaxx™ family of VMX™ series products, or a combination thereof, from ExxonMobil ™ Chemical Company.

In an embodiment, a multilayer film may include an extruded, outer skin layer. In an embodiment, the outer skin layer may include ethylene-propylene copolymer. In an embodiment, a multilayer film may include an extruded inner core layer comprising polypropylene and hydrogenated hydrocarbon resin. The multilayer film may include an extruded interior pigment layer intermediate to the inner core layer and outer skin layer, the pigment layer comprising polypropylene and hydrogenated hydrocarbon resin. The multilayer film may include an extruded image-rendering layer intermediate to the outer skin layer and the pigment layer, the image-rendering layer may be a voided layer including a thermally collapsible layer structure comprising polypropylene and ethylene-propylene copolymer having dispersed therein a plurality of voids, and in uncollapsed condition is substantially opaque to obscure from view the pigment layer. In an embodiment, the thermally collapsible layer structure is selectively collapsible by thermal printing to temporarily elevate localized temperature of the thermally collapsible layer structure to the melting point of polymer material forming same at select locations, so as to provide substantially transparent collapsed layer structure at the select locations for the pigment layer to be visible through the substantially transparent collapsed structure.

In an embodiment, a method of manufacturing a multilayer film comprises the steps of: (i) extruding in respective extruders resin compositions as herein disclosed to provide a plurality of respective extruded film layers; (ii) providing the plurality of extruded film layers from the extruders to orienting apparatus; and (iii) orienting the plurality of extruded film layers together on the orienting apparatus to form the multilayer film.

In an embodiment, a method for thermal printing of multilayer film comprises the steps of: (i) providing a multilayer film as herein disclosed to a thermal print head of a thermal printer; and (ii) activating the thermal print head for a time period sufficient to temporarily elevate localized temperature of a thermally collapsible layer structure of a respective image-rendering layer in the multilayer film to the melting point of polymer material forming same at select locations, so as to provide substantially transparent collapsed layer structure at the select locations for making visible through the substantially transparent collapsed structure a pigment layer of the multilayer film.

Prior to activating the thermal print head, in example embodiments, the multilayer film, having particles of a cavitating agent dispersed in the image-rendering layer, may undergo pre-heating to a temperature below a melting point of the image-rendering layer. Pre-heating the web (i.e., one or more layers of multilayer film) requires less dwell time (i.e., as compared to a cold web) in order to melt the voided polymer of the image-rendering layer. Thus, printing occurs quicker. Achieving this accelerated collapse is possible by various techniques, including conventional heat sources or novel sources, including hitting the same image point with two or more cycles of heat, such as with multiple rows of heater elements or multiple imaging heads in series. Configuring print head settings is known in the art, wherein print head software controlling the print head occurs through enabling logic, reduced to hardware and/or software, that an administrator or similarly authorized person sets on presented graphical user interfaces, direct entry, or the like. In one instance, an administrator may set the printer software to cycle the print heads at the right time and temperature(s), e.g., print heads in series could incrementally increase dwell time to ensure more complete collapse of the voided layer or be set to operate at higher temperatures. In other embodiments, the printer element is on and off, for each line of print. A certain off time is required to control the life of the heating resistor. In other words, the heater does not stay on constantly even if printing a solid patch. With each line, the resistor will cycle on and off. But the resistor can be configured to stay on a little longer than normal and this would provide an extra amount of time to drive to the melting point of the voided layer. Needless to say, an ordinarily skilled artisan would be enabled to make and configure a print head based on the foregoing and what is known to ordinarily skilled artisans in the computer and printing arts.

In an embodiment, apparatus for thermal printing of multilayer film comprises a thermal printer, or similar, having a thermal print head configured to be activated for a time period sufficient to temporarily elevate localized temperature of polymer material forming a thermally collapsible layer structure of a respective image-rendering layer in select locations or portions of multilayer film positioned in proximity to the thermal print head, to the melting point of polymer material forming the thermally collapsible layer structure at select locations, so as to provide substantially transparent collapsed void structure at the select locations to make visible through the substantially transparent collapsed layer structure a pigment layer of the multilayer film. It will be understood that such apparatus may have advantages, including improved image stability because the pigment layer is buried, lower cost, and reduced wear on print heads because of the non-abrasive and thermally stable techniques disclosed subject matter that require neither over-coatings nor ribbons, both of which are used in more complicated printing methods and apparatuses.

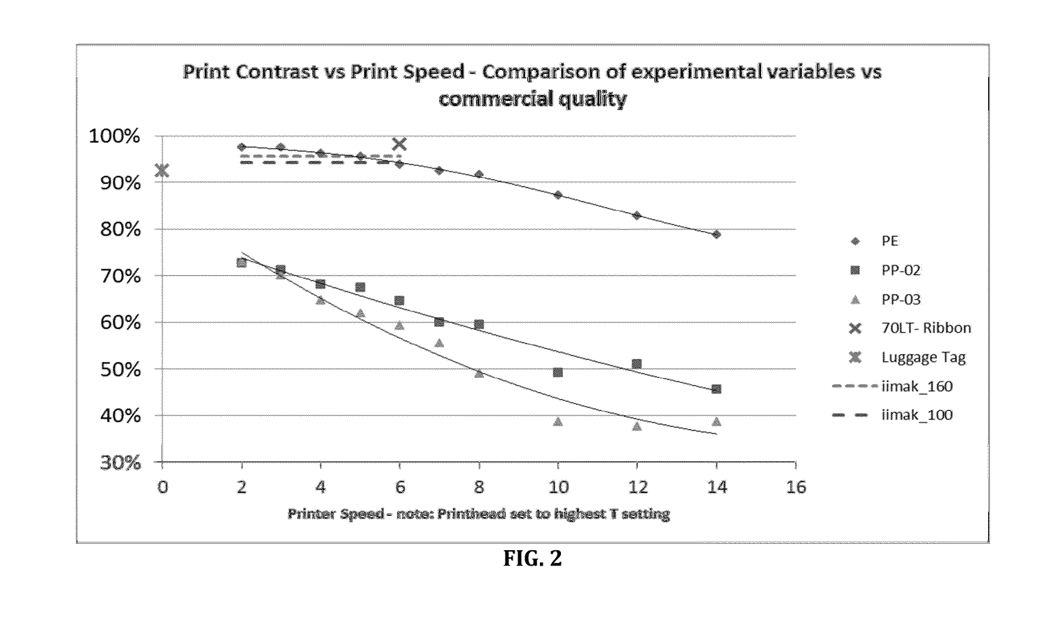

FIG. 2 illustrates the relationship of print contrast signal to print speed for various embodiments of the claimed invention and incumbent technologies. The PE (i.e., polyethylene), PP-02, and PP-03, wherein, “PP” is polypropylene, are invention formulations, whereas 70LT-Ribbon, Luggage Tag, Iimak_160, and Iimak_100 are incumbent technologies, including thermal transfer ribbon and direct thermal coatings. The luggage tag sample was printed at an unknown speed, and, so, is plotted on the y-axis to illustrate the associated print contrast signal. As print speed increases, the heater pulse time is shorter and the temperature of the voided layer does not reach the melting point deep enough into the layer to fully collapse the layer. As a result, the layer retains a certain opacity that causes the pigmented image portion to have a less intense color, and, therefore, a lower print contrast signal. The chart demonstrates the difference between a PE and a PP formulation, which is technically due to the lower melting point and higher thermal conductivity of the PE layer. With pre-heating, it may be possible to raise the print contrast signal of the PP version. As can be seen, embodiments of the invention achieve results that are consistent with incumbent technologies.

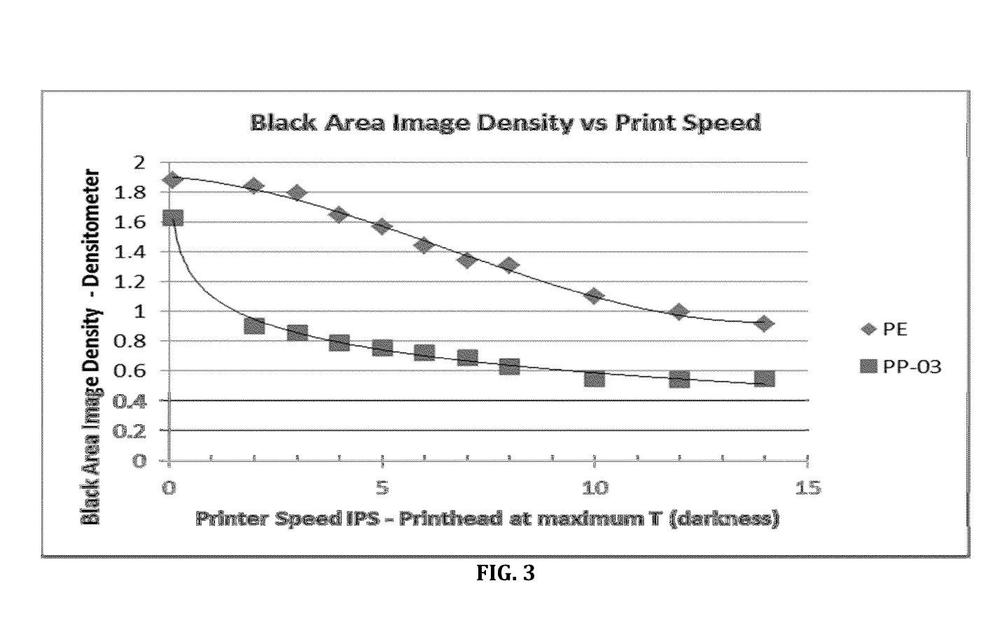

FIG. 3 shows a graphical display of image density in relation to print speed illustrating further the previous discussion with regard at least to FIG. 2. FIG. 3 is another depiction of the difference between the PE and PP formulations. Under the same conditions of printing and with similar constructions as in FIG. 2, the PE sample more fully collapses for a given print speed and renders a darker image than the PP sample. Again, if the PP sample were pre-heated, the PP sample would more fully collapse under the condition of the heat and pressure of the print head and render a darker image.

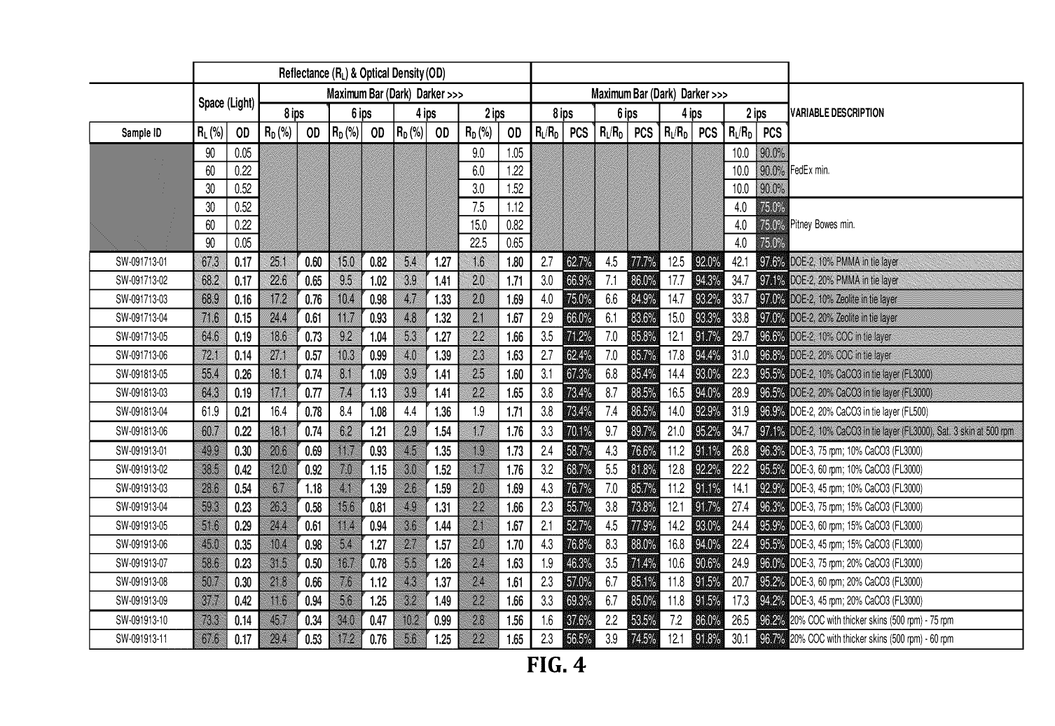

FIG. 4 is a tabular display of reflectance and optical density for some example embodiments. Progressing along the top row from left to right, the table columns for sample ID, reflectance and optical density measurements at various print speeds, and the variable description for a particular sample ID. The reflectance data comprises a comparison between the reflectance of the bars and that of spaces. Under a given set of illumination conditions, PCS is defined as: PCS=(R_{L}−R_{D})/R_{L}, where R_{D} is the reflectance factor of the dark bars and R_{L} is the reflectance factor of the light spaces (i.e., background).

In an embodiment, a multilayer film may be formed in what may be described as a single step, or reduced series of steps, by biaxial orientation on a tenter orienting apparatus of a multilayer film, the multilayer film being formed by extrusion. It will be understood that a suitable multilayer film may be formed of and may include, if desired, an extruded outer skin layer that may be substantially transparent, an extruded image-rendering layer beneath the outer skin layer that is opaque, an extruded pigment layer beneath the image-rendering layer, and an extruded core layer beneath the pigment layer. Further, it will be understood that the image-rendering layer may be a voided layer having therein a plurality of voids formed in the orienting step. It will be understood that when the multilayer film is biaxially oriented on the orienting apparatus, the image-rendering layer becomes substantially opaque by formation of the voids therein. It will be understood that the voids are created due to incompatibility of dispersed particles of cavitating agent and the polymer matrix in the image-rendering layer, by orienting the multilayer film to stress the polymer matrix of the image-rendering layer. It will be understood that, in embodiments, the cavitating agent may have a refractive index that is substantially the same as the polymer matrix that forms the collapsible layer structure of the image-rendering layer. When the cavitating agent has a refractive index near or equal to the refractive index of the collapsed matrix that includes the cavitating agent, then the cavitating agent does not refract light in the collapsed state, and, therefore, does not hinder the intensity of the now visible pigment layer caused by a printing and/or pressure-applying device collapsing the collapsible layer.

It will be understood that, in embodiments, the dimension of voids may be from about less than 0.5 to 3 or 4 microns. In embodiments, durability is improved, production cost is significantly reduced relative to ribbon systems technology and thermal coating technology for thermal printing, construction of a multilayer film is simplified, and reliability of the forming method is increased. Embodiments provide simplified methods for making a multilayer film as disclosed. It will be understood that a multilayer film may be produced in a simplified, or one-step, process on existing orienting equipment at high throughput, and has reduced production cost relative to a ribbon systems or coating system for thermal printing. It will be understood that a multilayer film as disclosed may be printed on conventional thermal printing equipment. A multilayer film according to embodiments has at least one polymer layer above the buried pigment layer, and for this reason, at least, has improved durability and toughness for easier handling. A multilayer film according to embodiments may be formed without application of a thermal print coating to the formed substrate.

In addition to the foregoing embodiments, multilayer films may include at least one coating (i.e., additional layer(s)) selected from a group consisting of barrier coatings, adhesive-receptive coatings, slip coatings, and printable coatings. Barrier coatings may render the multilayer film impervious to solvents, aggressive chemicals, oils, grease, etc. Adhesive-receptive coatings permit the multilayer film to adhere to other layers or other materials. Slip coatings prevent build-up or sticking during operation of the printer, embosser or other device. Adding printable coatings to the multilayer film permits one type of printing on the structure, which also has the ability for thermal printing and/or application of a pressure-applying device to collapse the collapsed structure at the select locations and make visible the internal pigment layer, i.e., that layer beneath the collapsed structure. In still additional embodiments, the internal pigment layer may be voided, and, thereby, making it sensitive to temperature and/or pressure. By being voided, the internal pigment layer's pigment darkens when made visible by action on the collapsible layer, and, thereby, assists in driving the intensity of the pigment so as to at least partially lift the burden on the topical layer(s) to create the contrast for purposes of pigment visibility in printing or embossing.

Embodiments provide improved multilayer films, methods for making the same, resin compositions for multilayer films, and methods and apparatus for thermal printing of multilayer films. Embodiments provide resin compositions for making multilayer films for thermal printing and having skin layers, with multiple advantages in manufacturing and converting.

Although specific embodiments are illustrated and described herein, it will be appreciated by those of ordinary skill in the art that certain variations may be made from the specific embodiments described herein without departing from the scope of this disclosure. This application is intended to cover any adaptations or variations. For example, although described in terms of the specific embodiments, one of ordinary skill in the art will appreciate that implementations may be made in different embodiments to provide the required functions. Embodiments may provide, for example, multilayer films that are suitable to replace non-laminated printable paper products like receipts, paper forms, wrapping paper, cartons, shelf labels, and paper bags. Embodiments may provide, for example, multilayer films that are suitable components of laminated products for applications such as identification cards, credit cards, and luggage tags. One of skill in the art will appreciate that names and terminology used herein are not intended to limit embodiments. Additional subject matter may be added to correspond with future enhancements without departing from the scope of embodiments and this disclosure.

What is claimed is:

1. An oriented multilayer film for printing, comprising:
an extruded outer skin layer;
an extruded internal pigment layer; and
an extruded image-rendering layer intermediate to the outer skin layer and the pigment layer, the image-rendering layer comprising a voided layer having a collapsible layer structure having dispersed therein a plurality of voids, the plurality of voids being formed by orienting the multilayer film comprising the extruded image-rendering layer and the collapsible layer structure in uncollapsed condition being substantially opaque in order to obscure the pigment layer therebeneath.

2. The multilayer film of claim 1, wherein the collapsible layer structure is selectively collapsible by thermal printing to temporarily elevate localized temperature of the collapsible layer structure to a melting point thereof at select locations, so as to provide a collapsed structure at the select locations, the pigment layer being visible through the collapsed structure.

3. The multilayer film of claim 1, wherein the collapsible layer structure is selectively collapsible by applying pressure to select locations, so as to provide a collapsed structure at the select locations the pigment layer being visible through the collapsed structure.

4. The multilayer film of claim 1, wherein the pigment layer comprises a composition selected from at least one member of a group consisting of polyethylene, polypropylene, hydrogenated hydrocarbon resin, and combinations thereof.

5. A multilayer film of claim 1, wherein the collapsible layer comprises a composition selected from at least one member of a group consisting of high density polyethylene, polypropylene, hydrogenated hydrocarbon resin, and combinations thereof.

6. The multilayer film of claim 1, further comprising the collapsible layer structure comprising at least one elastomer selected from a group consisting of propylene-based elastomer, ethylene-propylene copolymer, and combinations thereof.

7. The multilayer film of claim 1, further comprising the collapsible layer structure comprising hydrogenated hydrocarbon resin, and in combination therewith, propylene-based elastomer, ethylene-propylene copolymer, and combinations thereof, wherein the pigment layer comprises polypropylene and hydrogenated hydrocarbon resin.

8. The multilayer film of claim 1, wherein the outer skin layer comprises a composition selected from at least one member of a group consisting of ethylene-propylene copolymer, polyethylene, high density polyethylene, medium density polyethylene, linear low density polyethylene, propylene homopolymers, terpolymers, matte resins, antiblocking additives, and slip agents.

9. The multilayer film of claim 1, further comprising a core layer beneath the pigment layer, the core layer comprising a voided layer or a non-voided layer.

10. The multilayer film of claim 9, wherein the core layer comprises a composition selected from at least one member of a group consisting of polyethylene, polypropylene, hydrogenated hydrocarbon resin, and combinations thereof.

11. The multilayer film of claim 1, further comprising particles of a cavitating agent dispersed in the image-rendering layer, the particles having a refractive index comparable to the collapsible layer structure.

12. The multilayer film of claim 1, further comprising an additional extruded skin layer located non-adjacent to the extruded, outer skin layer.

13. The multilayer film of claim 1, further comprising at least one coating selected from a group consisting of barrier coatings, slip coatings, adhesive-receptive coatings, and printable coatings.

14. The multilayer film of claim 1, wherein the extruded internal pigment layer is voided or not voided.

15. A method of making a multilayer film, the method comprising the steps of:
extruding in respective extruders resin compositions having the compositions specified in claim 1 to provide a plurality of respective extruded film layers, the plurality of extruded film layers comprising an extruded image-rendering layer having dispersed therein a cavitating agent;
providing the plurality of extruded film layers from the respective extruders to an orienting apparatus; and
orienting the plurality of extruded film layers together on the orienting apparatus to form the multilayer film, the orienting forming a plurality of voids in the extruded image-rendering layer, the plurality of voids making the image-rendering layer substantially opaque.

16. The method of claim 15, further comprising selecting the cavitating agent having particles with a refractive index comparable to a collapsible layer structure that includes the image-rendering layer.

17. A method for printing a multilayer film, the method comprising the steps of:
providing a multilayer film as specified in claim 1 to a thermal print head of a thermal printer or a pressure-applying device; and
activating the thermal print head or the pressure-applying device for a time period, sufficient to apply a member of a group consisting of localized temperature, localized pressure, and combinations thereof, to a collapsible layer structure of a respective image-rendering layer in the multilayer film at select locations, so as to provide a collapsed structure at the select locations for making visible a pigment layer of the multilayer film.

18. The method of claim 17, further comprising pre-heating, prior to the activating, the multilayer film having particles of a cavitating agent dispersed in the image-rendering layer, wherein the pre-heating is to a temperature below a melting point of the image-rendering layer.

19. Apparatus for thermal printing of multilayer film, comprising:
a thermal printer having a thermal print head configured to be activated for a time period sufficient to temporarily elevate localized temperature of a thermally collapsible layer structure of a respective image-rendering layer at select locations of the multilayer film positioned in proximity to the thermal print head, to a melting point at select locations for deforming the thermally collapsible layer structure.

20. Apparatus for printing of multilayer film, comprising:
a pressure-applying device configured to be activated for a time period sufficient to temporarily apply localized pressure to a collapsible layer structure of a respective image- rendering layer at select locations of the multilayer film positioned in proximity to the pressure- applying device for deforming the collapsible layer structure.
